(19) United States
(12) Patent Application Publication
(10) Pub. No.: US 2010/0211434 A1
(43) Pub. Date: Aug. 19, 2010

(54) SYSTEM AND METHOD FOR GENERATING SALES LEAD INFORMATION AND USER INTERFACE FOR DISPLAYING THE SAME

(76) Inventor: Michael McKean, Rehoboth Beach, DE (US)

Correspondence Address: The Small Patent Law Group LLP;Suite 725, 225 S. Meramec, St. Louis, MO, 63105, US

(21) Appl. No.: 12/371,369

(22) Filed: Feb. 13, 2009

(51) Int. Cl. G06Q 10/00; G06F 3/048

(52) U.S. Cl. 705/10; 715/764

(57) ABSTRACT

A system and method for generating sales lead information and user interface for displaying the same. The method includes receiving a request for sales lead information corresponding to a time slot in a displayed user interface calendar and based on selection of a selection element in the time slot of the user interface calendar and associating the time slot with time slot criteria for searching for groups, wherein information relating to the groups is stored in database. The method further includes determining at least one group satisfying the time slot criteria and generating sales lead information relating to the at least one group.

### BACKGROUND OF THE INVENTION

This invention relates generally to sales force automation systems, and more particularly, to systems and methods for generating sales lead information relating to groups or organizations that hold events in venues having space for temporary use.

Sales Force Automation (SFA) systems provide electronic tools to help facilitate managing client and potential client information for use in automating sales and sales force management functions. SFA systems are typically information systems used for sales management and may be combined with marketing information to provide a customer relationship management system.

SFA systems may include different components, for example, a contact management component that tracks business contacts that have been made with a particular customer, the purpose of the contact, any follow up that may be needed, other related information, etc. Other components that may form part of SFA systems include sales forecasting components, order or event management components and product knowledge components.

SFA systems are intended to create some type of competitive advantage, as well as provide a more efficient approach to client development, thereby resulting in improved productivity of sales personnel. Known SFA systems typically include one or more user interfaces to help organize, store and retrieve information. Moreover, known SFA systems can require substantial user input to generate a list of potential sales leads. Additionally, it may be difficult to change different settings within the SFA systems to modify the criteria for generating the list of potential sales leads. Additionally, SFA systems do not typically include a lead generation and/or scoring component. The difficulties with known SFA systems can result in inefficiencies.

### BRIEF DESCRIPTION OF THE INVENTION

In accordance with an embodiment of the invention, a method, implemented at least in part by a computing system, is provided. The method includes receiving a request for sales lead information corresponding to a time slot in a displayed user interface calendar and based on selection of a selection element in the time slot of the user interface calendar and associating the time slot with time slot criteria for searching for groups, wherein information relating to the groups is stored in database. The method further includes determining at least one group satisfying the time slot criteria and generating sales lead information relating to the at least one group.

In accordance with another embodiment of the invention, a user interface for requesting sales lead information is provided that includes a calendar matrix having a plurality of cells corresponding to time slots for a space in a venue. The user interface further includes a selection element in at least one available time slot, with the selection element selectable by a user interface selection device to initiate generation of sales lead information.

In accordance with yet another embodiment of the invention, a computer program product for scoring groups is provided. The computer program product is embodied on one or more computer-readable storage media and includes computer-readable program code causing a computing device to perform the method of receiving a request for sales lead information corresponding to a time slot in a displayed user interface calendar and based on selection of a selection element in the time slot of the user interface calendar. The method further includes associating the time slot with time slot criteria for searching for groups and wherein information relating to the groups is stored in database. The method also includes determining at least one group satisfying the time slot criteria and generating sales lead information relating to the at least one group.

In still another embodiment of the invention, a system for generating sales lead information is provided that includes a user interface configured to receive a request for sales lead information corresponding to a time slot in a displayed user interface calendar and based on selection of a selection element in the time slot of the user interface calendar by a user interface selection device. The system further includes a computer configured to associate the time slot with time slot criteria for searching for groups and wherein information relating to the groups is accessed from a database. The computer is further configured to determine at least one group satisfying the time slot criteria and generate sales lead information relating to the group. The system also includes a display configured to display the sales lead information.

### BRIEF DESCRIPTION OF THE DRAWINGS

FIG. 1 is a diagram illustrating a system in connection with which various embodiments of the invention may be implemented or operated.

FIG. 2 is a flowchart of a method for generating sales lead information in accordance with various embodiments of the invention.

FIG. 3 is a screenshot of a user interface formed in accordance with various embodiments of the invention.

FIG. 4 is a screenshot of another user interface formed in accordance with various embodiments of the invention.

FIG. 5 is a table illustrating group information stored in accordance with various embodiments of the invention.

FIG. 6 is a screenshot of another user interface formed in accordance with various embodiments of the invention.

FIG. 7 is a screenshot of another user interface formed in accordance with various embodiments of the invention.

FIG. 8 is a screenshot of another user interface formed in accordance with various embodiments of the invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry or software components. Thus, for example, one or more of the functional blocks (e.g., processors or memories) may be implemented in a single piece of hardware (e.g., a general purpose signal processor or random access memory, hard disk, or the like) and in one or more different software components. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments of the invention provide a system and method that generates sales lead information, especially sales lead information relating to groups or organizations that temporarily occupy space in a venue (e.g., rent a meeting room in a hotel). The various embodiments also provide user interfaces that allow a user to easily generate sales lead information and associate the sales lead information with other information within the system, for example, available time slots or openings for a space in a venue.

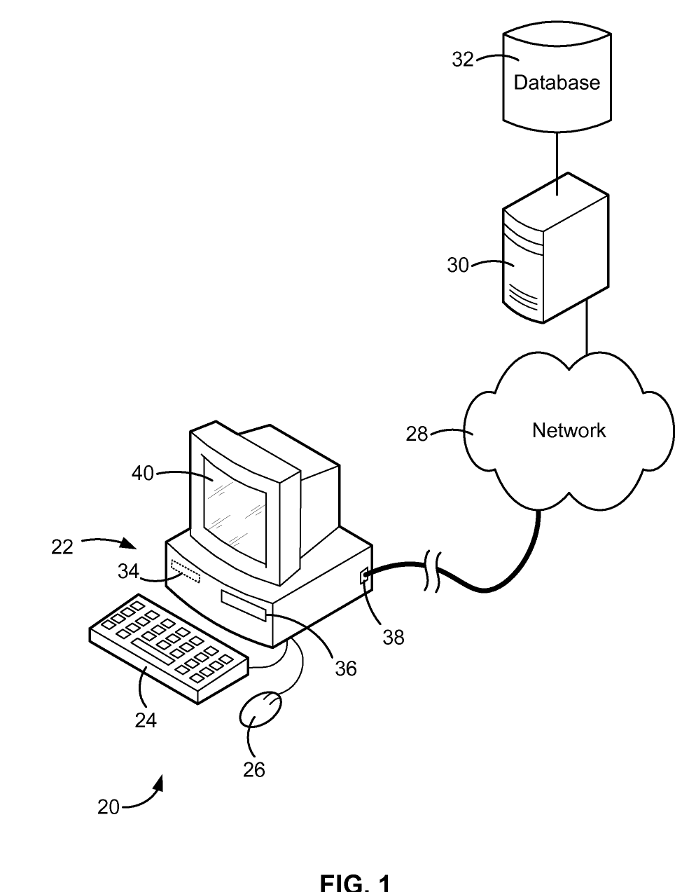

Embodiments of the invention enable a user to select, review and otherwise manipulate electronically stored sales data and related information using a system 20 as illustrated in FIG. 1. The system 20 allows a user to access group information and uses different criteria or indicators for generating sales lead information. For example, the system 20 may include a client-side device, such as a computer 22 that receives user inputs via one or more user interface selection devices, illustrated as a keyboard 24 and mouse 26 and provides sales lead information, such as via a network 28 based on predefined or user defined criteria or indicators. The system 20 may include a server 30 that is configured to receive sales lead information requests from a user (e.g., request for suggested groups to fill an open time slot in a room of a particular venue) accessing the network 28 with the computer 22. The server 30 receives the requests and processes the requests to generate sales lead information. It should be noted that the suggested sales lead information may be based on a scoring of the groups or organizations, which scoring is based on information relating to prior activity, such as past group meeting activities in different venues or different locations within the same venue that are stored in a database 32 connected to the server 30. One example of a scoring system for scoring groups or organizations is described in co-pending U.S. patent application Ser. No. 12/371,282 entitled “SYSTEM AND METHOD FOR SCORING GROUPS” commonly owned and disclosure of which is hereby incorporated by reference in its entirety. However, the suggested sales lead information may be based on other factors or criteria (and information) as described in more detail herein.

The received requests and results from the processing also may be stored in the database 32. The results may include a list of groups that are potential sales leads and the likelihood that such a group may be interested in renting a space in a venue at a particular time.

It should be noted that the processing of the requests may be performed locally at the computer 22 that may include an internal storage device 34 (e.g., hard-disk drive) for storing information relating to time slots for a venue and prior activity information, as well as instructions that cause a processor of the computer 22 to perform sales lead information generation and a user interface to perform display operations of the various embodiments. The computer 22 also may include an external reading/writing device 36 (e.g., CD or DVD drive) for receiving a computer readable medium. A network interface 38 (e.g., local area network (LAN) connection) may be provided to allow connection to the network 28. Thus, the system 20 may provide a server and computer based interactive system that can be accessed locally, through an intranet, or through the World Wide Web or through one or more Internets via a graphical user interface as described in more detail herein. It also should be noted that one or more computers 20 located at the same or different location may be provided.

The server 30 may be configured to generate sales lead information for selected open time slots in a calendar displayed as part of a user interface. The sales lead information may be, for example, a list of groups or organizations that are displayed based on the desired time slot and other criteria for the space of the venue. The server 30 also may be configured to display information for each group (e.g., past activity information for the group) and then display on a display 40 of the computer 22 that information. The user can select an individual group to obtain additional information, for example, past purchasing indicators for the particular group or scoring information for the group. It should be noted that when reference is made herein to a group, this refers to any type of group, organization, entity, company, etc.

In various embodiments, the database 32 stores calendar information for one or more spaces available for temporary occupancy in a venue. For example, the information may include available and non-available time slots for the space, as well as the current groups that are scheduled to occupy one or more spaces. The database 32 also stores information (e.g., scoring information) for different groups or organizations that is used to generate sales lead information, for example, for open time slots for spaces in a venue.

The information may be acquired and stored in any manner. For example, the calendar information may be stored in a format or file compatible with a calendar user interface as described herein or other commercially available online calendar system. The open time slot information may be imported or downloaded directly from the calendar program and the suggested sales lead information uploaded directly to the calendar program. Additionally, specific information may be stored for each group or organization, such as the name of each group, and for each past activity for that group, the name of the past activity, the location of the past activity (and associated information such as the type of the location, amenities of the location, etc.), the time and date of the past activity, the size of the space for the last activity, etc. In general, the information includes information regarding the circumstances and characteristics of the venue for the past activity.

The stored information regarding the groups in some embodiments includes a unique identifier for each group. In addition to a unique identifier, the group's past meeting activity is stored. Information relating to the meeting activity may be stored according to indicators (or other groupings), for example, price (or class) segmentation, size (or size compatibility), brand (or brand affinity), time of year (or time of year propensity), time of week (or time of week propensity), amenity (or amenity affinity), and several geographic indicators are described herein. Each indicator includes a plurality of categories or defined sub-indicators. The categories in some embodiments are predetermined, but may be changed. The information relating to the groups or organizations may be acquired and stored in any manner. For example, the information may be acquired from customer surveys, field research, mystery shoppers, actual purchasing or meeting history information, such as from a contracted venue, etc. In general, the information is any type of information that has been acquired and stored relating to the past activity of the group or organization or useful to determine whether a group or organization is likely or unlikely to want to rent or lease a space in a venue, especially on a particular date and at a particular time.

Various embodiments of the invention generate sales lead information based on criteria, which may be predetermined or predefined. The criteria used to generate the sales lead information may be automatically selected (e.g., based on an open time and date slot for a space in a venue) or manually selected by a user (e.g., based on particular preferences for a particular venue). In some embodiments, a single user interface allows a user to identify open time slots for one or more spaces in a venue, select the time slot and request sales lead information for the one or more spaces in the venue for the open time slot.

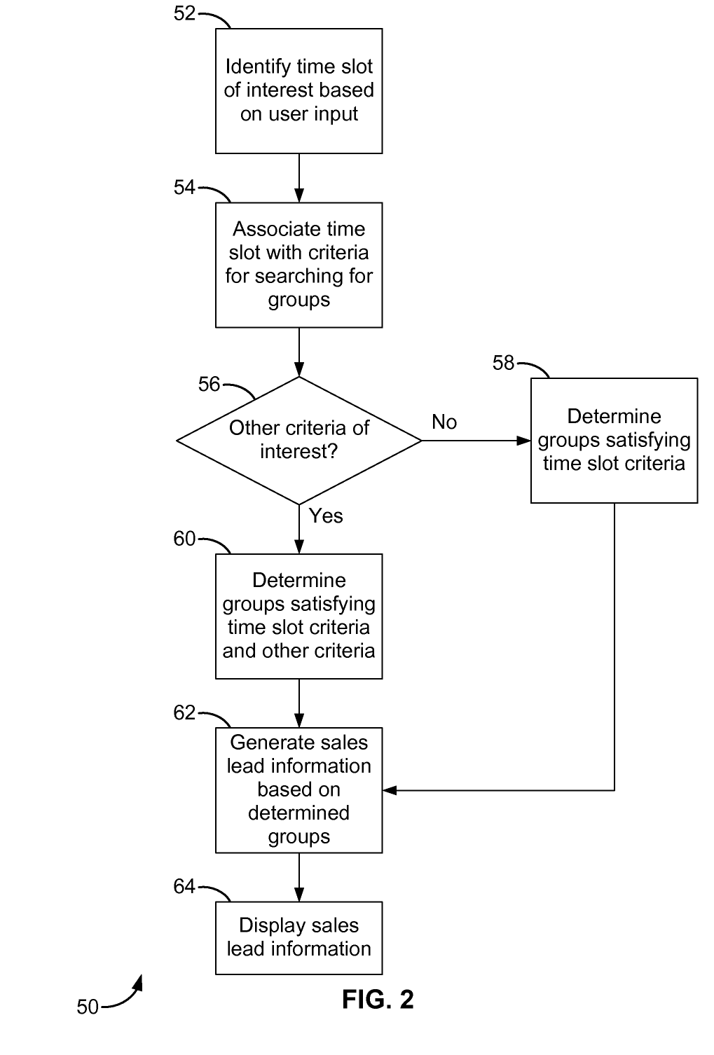

The various embodiments use stored information relating to groups or organizations (e.g., past activity information for groups) to determine whether groups satisfy certain criteria, which is then used to generate sales lead information. In particular, a method 50 as shown in FIG. 2 is provided for generating sales lead information based on groups satisfying certain criteria that may be automatically or manually defined. The method 50 may be performed, for example, by the system 20 (shown in FIG. 1) to generate sales lead information for display on one or more user interfaces. The sales lead information may relate to, for example, leads for occupying venues having available space for a certain time period (e.g., a one day meeting). The method 50 includes identifying at 52 one or more time slots of interest based on a user input. For example, the time slot may be portion of a day in which a room in a hotel is available to be occupied (e.g., room available for rent for several hours).

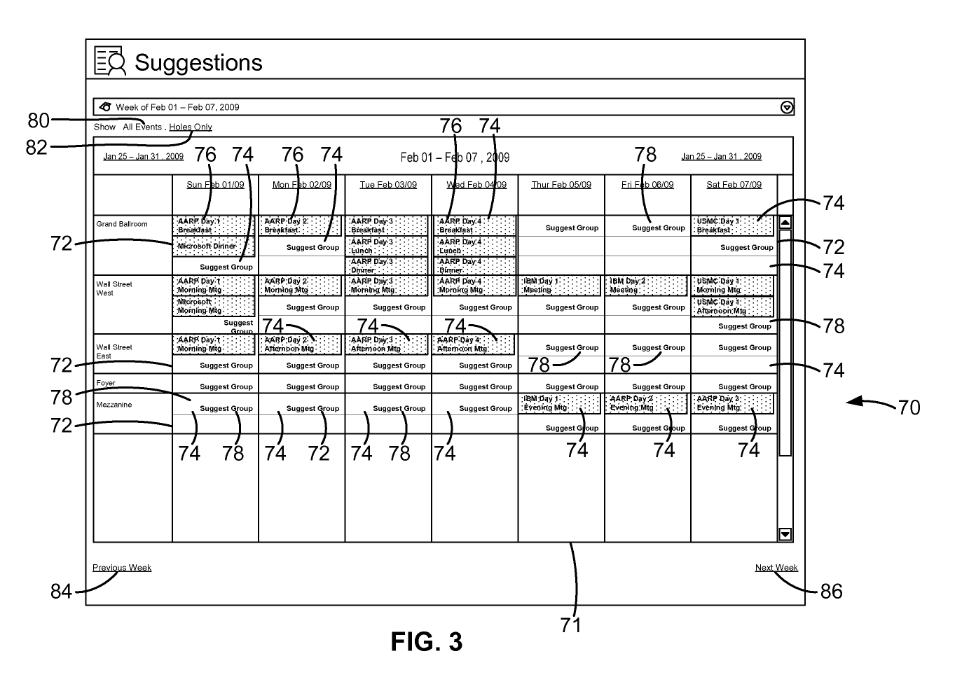

In some embodiments, a user interface 70 is provided and configured in a calendar format as shown in FIG. 3. The use interface 70 includes a plurality of cells 72 each containing event information, for example, events scheduled for different rooms in a hotel. Each cell 72 may be sub-divided into a plurality of sub-cells 74. For example, in the weekly format shown in FIG. 3, each column of cells 72 defines a day and each row of cells corresponds to a particular space, for example, a room in a hotel, thereby defining a calendar matrix 71. Within each of the cells 72, a plurality of sub-cells 74 (three sub-cells 74 are shown for each cell 72 in the first row of the calendar 71) are provided corresponding to different time blocks of the day. For example, the time blocks may be defined as morning, afternoon and evening. It should be noted that more or less sub-cells 74 may provided in each of the cells 72. Moreover, a different number of sub-cells 74 may be provided in each of the cells 72 as shown.

Within each of the cells 72, and in this example, each of the sub-cells 74, unavailable time slots include text 76 identifying a group that is scheduled to occupy the room at the particular time block. For example, the text 76 may include a group name and the sub-cell 74 may be highlighted (e.g., color coded) to indicate that the room is scheduled to be occupied (e.g., rented) during that time period. Within each of the cells 72, and in this example, each for the sub-cells 74, available time slots do not include any text 76 identifying a group scheduled for that time slot. In the available time slots, the sub-cells 74 include a selection element 78 that allows a user to request sales lead information to be generated. In particular, while hovering over the selection element 78 (which is identified in the user interface 70 by underlined “Suggest Group” text), and for example, left-clicking on a mouse, a determination is thereby made that the time slot is of interest to the user, for example, that the user desires to fill the time slot (e.g., schedule a group to occupy the room at the time slot associated with the cell 72). It should be noted that each sub-cell 74 corresponding to an available time slot may not include the selection element 78, but each cell 72 having at least one sub-cell 74 with an available time slot includes the selection element 78 in at least one of the sub-cells 74 of that cell 72.

It also should be noted that different display configurations may be provided by the user interface 70. For example, the illustrated display shows all events, which is selected by the selection element 80 (identified by the underlined “All Events” text). The display configuration of the user interface 70 also may be changed such that only available time slots are shown. For example, using selection element 82 (identified by the underlined “Holes Only” text), the calendar matrix 81 displays only sub-cells 74 corresponding to available time slots.

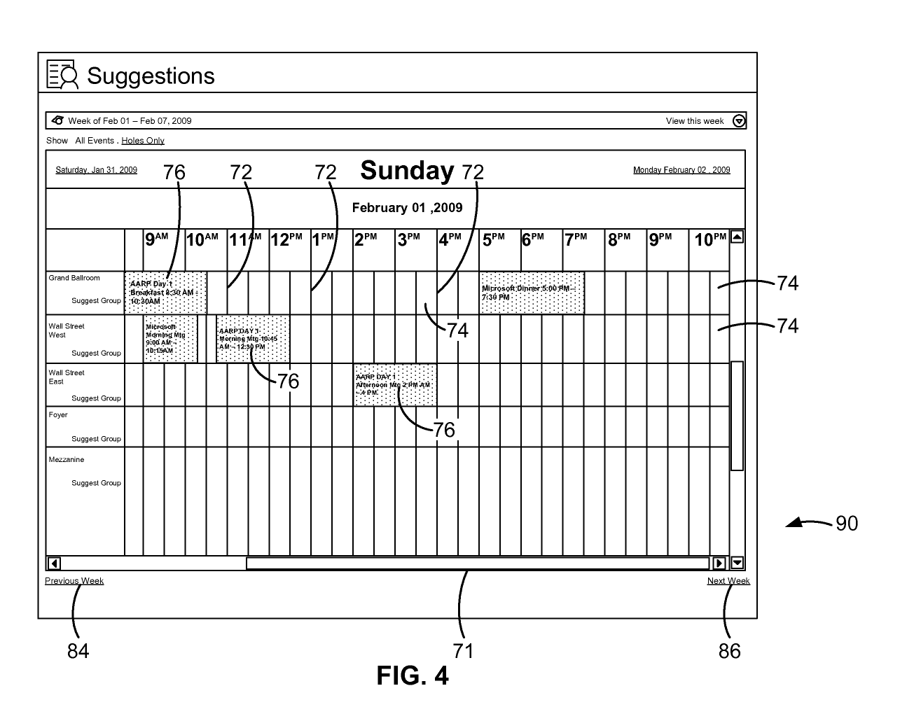

It further should be noted that different time periods, for example, different weeks may be displayed using one of the selection elements 84 and 86 (identified by the underlined “Previous Week” and “Next Week” text, respectively). Additionally, the calendar matrix 71 may correspond to different time periods. For example, as shown in a user interface 90 of FIG. 4, the time matrix 71 corresponds to a single day with each cell 72 corresponding to an hour within the day and each sub-cell 74 corresponding to a portion of an hour (e.g., 30 minutes). It should be noted that like numerals represent like elements throughout the various embodiments.

It further should be noted that a group may be scheduled to occupy a room over a period that extends across more than one time slot. Accordingly, the text 76 may extend across multiple cells 72 or sub-cells 74. Additionally, in the user interface 90, in some embodiments, one selection element 78 is provided in connection with each room (each row of the calendar matrix 71) and not with each available time slot.

Referring again to the method 50 of FIG. 2, after one or more time slots of interest are identified based on the user input, for example, based on a user choosing a selection member 78 in a sub-cell 74 of the user interface 70 (all shown in FIG. 3), the time slot corresponding to the sub-cell 74 is associated with criteria for searching for groups. For example, the time slot corresponds to a particular time on a particular date, thereby defining a time and date of interest. Additionally, the sub-cell 74 corresponding to the time slot is associated with a space, for example, a room in a hotel. Thus, the sub-cell 74 may identify time, date and space criteria for searching as described in more detail herein. It should be noted that the criteria may define multiple factors for searching. For example, based on the room corresponding to the sub-cell 74, a size of space criterion based on the room size may be identified.

After search criteria associated with the time slot are identified, a determination is made at 56 whether there are other criteria of interest. For example, a determination is made as to whether the space is in a specific hotel of a particular type, thereby defining other criteria, for example, price, region, market, brand, hotel type and amenities criteria. For example, the criteria may correspond to indicators or preferences of a user (e.g., operator of a hotel).

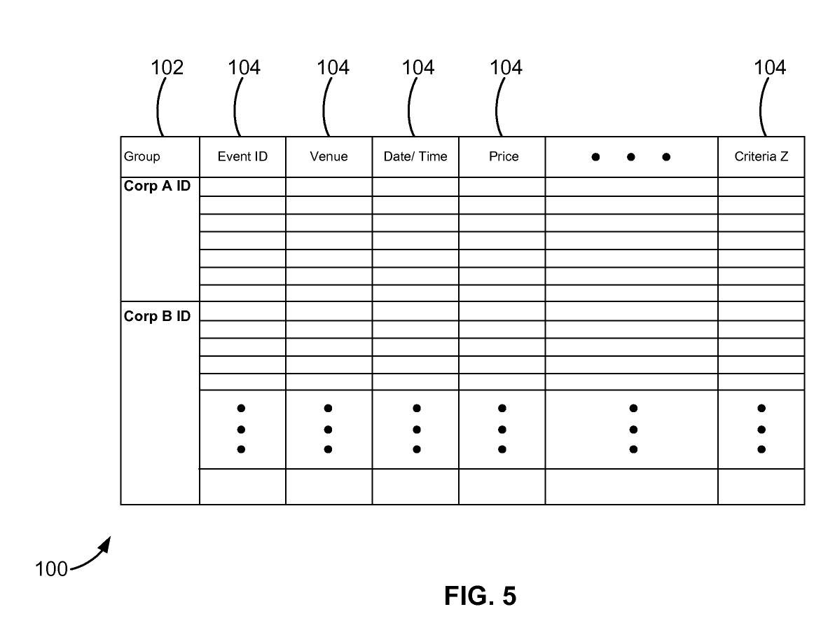

Thereafter, if no other criteria of interest are identified, then at 58 groups satisfying the time slot criteria are determined at 58. If other criteria of interest are identified, then at 60 groups satisfying the time slot criteria and additional criteria are determined. For example, a database of past activity information for a plurality of groups may be accessed to identify groups satisfying one or more of the criteria. The past activity information may include, for example, specific information regarding past events held by groups at specific venues. The past activity information may be stored in database as shown in FIG. 5. For example, a table 100 representing a database of past activity information for a plurality of groups is shown. The rows and columns of the table 100 represent, for example, different memory locations within the database. As illustrated, and for example, for groups identified in column 102, a plurality of past activity information is stored for each of the plurality of criteria or categories corresponding to columns 104. For example, for each criterion, specific information may be stored. It should be noted that the stored past activity information is not limited to the information illustrated (Event ID, Venue, Date/Time, Price are illustrated), but may include any information relating to past activities for a group and that may be associated with a one or more criteria or categories (e.g., Region for Venue, Market for Venue, Brand of Venue, Time of Event, Amenities, Hotel Type, Tract, etc.). Other information relating to the groups also may be stored. For example, the criteria or categories may include the following: Event Identification (ID), Group ID, Hotel ID, Event Date, Name, Researcher Notes, User ID, Time Slot, Hot Lead, Total Square Footage, Total Square Footage Catered, etc.

The past activity information may be provided for each of a plurality of events of each of the groups. The past activity information also may correspond to one or more than one criteria or category. Accordingly, groups satisfying one or more criteria may be determined based on stored past activity information. For example, for each criteria corresponding to a selected sub-cell a determination may be made whether a group exceeds a predetermined threshold value for that criteria. Each of the criteria may have a different threshold value. In some embodiments, the threshold value is a percentage value for each of the criteria that correspond to, for example, the total percentage of events (based on total events) for a group that satisfies the particular criteria. For example, for time based criteria, such as time of day or time of year, the group past activity may have to exceed at last seventy percent or eighty percent. Accordingly, if the time slot is in the morning on a Monday in January, the past activity information for a group may be accessed to determine if the past activities for the group exceed the threshold value for each of the criteria. For example, the past activity may have to meet exactly the time slot criteria, for example, past events that occurred in the morning on a Monday in January or may have to meet with criteria within a certain tolerance, such as events that occurred in the morning in the beginning part of the week during the winter. The group may have to satisfy any one of the criteria threshold values, more than one of the criteria threshold values, all of the criteria threshold values or some of the criteria threshold values. Thus, in an example where the criteria threshold value is eighty percent, the past activity for the group may have to exceed eighty percent in one or more of the criteria categories.

If the criteria also include additional criteria, then non-time based determinations of whether past activity for a group exceed the threshold values are used. For example, criteria such as the location (e.g., region or city), price level (e.g., luxury) or size of space (e.g., greater than 2000 square feet) also may be used in the determination. It should be noted that in some embodiments, the threshold values for these non-based criteria may be higher than or lower than the time-based criteria. In other embodiments, the threshold values are the same. The threshold values may be set by a user or automatically determined, for example, based on the venue and space corresponding to the time slot that is available. Thus, a user may enter, for example, the location and price criteria or the criteria may be determined automatically based on the type of hotel having the available space.

In other embodiments, groups satisfying the criteria are determined based on a scoring system as described in co-pending U.S. patent application Ser. No. 12/371,282 entitled “SYSTEM AND METHOD FOR SCORING GROUPS.” In still other embodiments, groups satisfying the criteria are determined based on accessing publicly available or subscription databases, such as the databases having information acquired from customer surveys, field research, mystery shoppers, actual purchasing or meeting history information, such as from a contracted venue, etc. It should be noted that the determination of whether a group satisfies the criteria may be based on any type or kind of information.

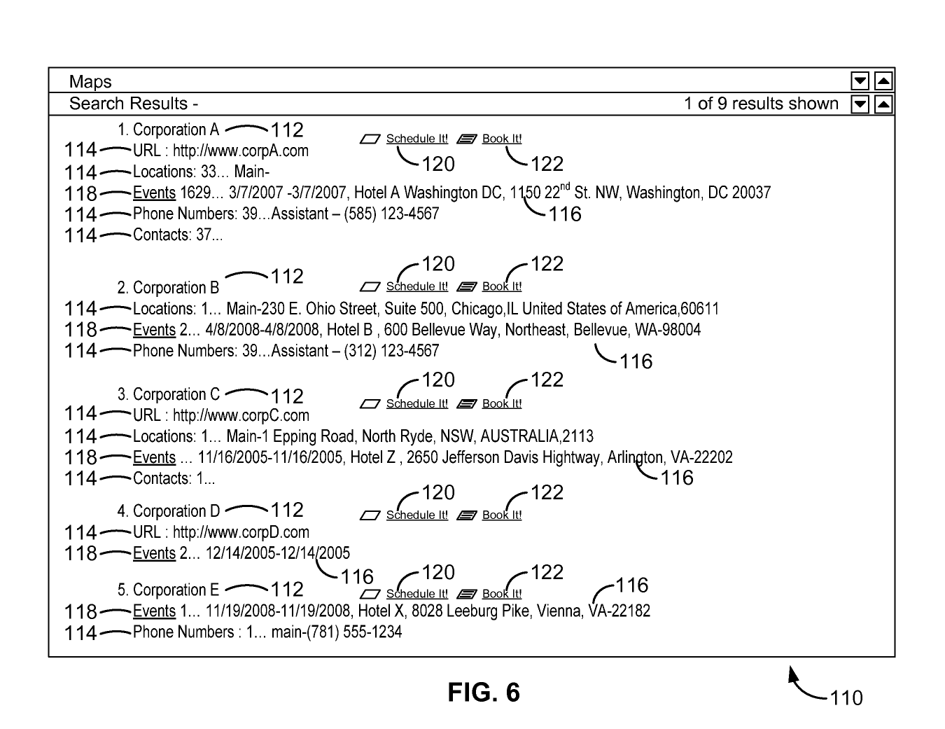

Referring again to the method 50 of FIG. 2, after groups satisfying the criteria are determined, sales lead information is generated at 62 based on the determined groups and optionally may be displayed at 64. For example, a user interface 110 as shown in FIG. 6 may be provided that includes a list of sales lead information. For example, a plurality of groups may be listed and includes text 112 identifying the name of each group and text 114 identifying information relating to the group, for example, a website address, phone number(s), locations or addresses, the number of contacts, etc. Additionally, text 116 corresponding to an exemplary event may be provided, which may identify the name of the venue and the location of the venue for the past event. The user interface 110 also may include a selection element 118 (illustrated as underlined “Events” text) that is selectable by a user, for example, using a mouse as described herein that links to another user interface displaying all events for the group including the specific information for the events such as date, time, space size, etc. or other stored information relating to the different criteria.

A user may then initiate contact with one or more of the groups. Optionally, a user may use a selection element 120 or 122 to initiate a third party request to contact the group, for example, for a fee, and to set up a meeting to discuss the available time slot at the venue. If a group is contacted and agrees to rent the space for the available time slot, a user may input the group information, for example, using a keyboard, and which will then display text in the sub-cell as described in more detail herein.

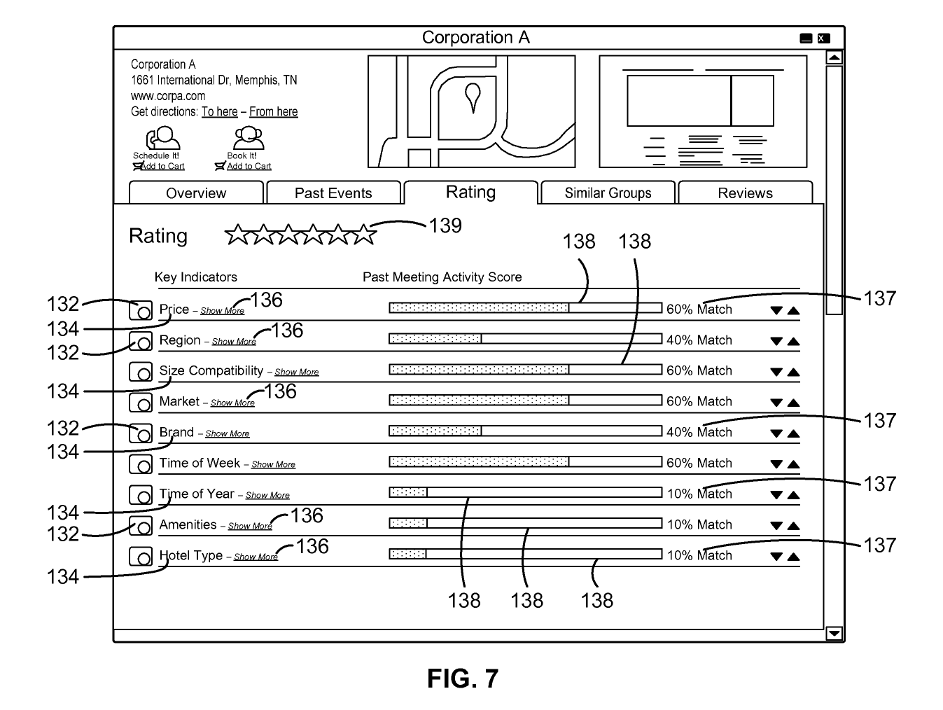

It should be noted that the additional information for the group may include scoring information for the group as illustrated in the user interface 130 shown in FIG. 7, which may be provided in accordance with the system described in co-pending U.S. patent application Ser. No. 12/371,282 entitled “SYSTEM AND METHOD FOR SCORING GROUPS.” The user interface 130 includes a graphic 132 and associated text 134 corresponding to each of the plurality of indicators that correspond to criteria as described herein. The user interface 130 also includes a selection element 136 associated with each of the displayed indicators that allows a user to obtain more specific information for each of the criteria. For example, underlying scoring information for each of the indicators may be provided that identifies the total number of tracked events/meetings for the organization and the total number that fall into the selected category for each indicator (e.g., 6 out of 10 events match the category).

A percentage score value 137 (e.g., 60% Match) is displayed in combination with each of the indicators identified by the text 134. A graphic indicator 138, for example, a color coded bar may be provided to indicate the relative percentage score value for each of the indicators. Additionally, a star rating indicator 139 may be displayed corresponding to a star value for the group based on the scoring for the group.

It should be noted that the user interfaces, for example, the user interface 130 may include a plurality of selection elements 101, displayed for example, as tabs, to allow selection of different user interfaces. For example, using a user interface selection member (e.g., a mouse or touchpad) a user may select one of the selection elements 101, such as by hovering over the selection element 101 and clicking the user interface selection member. For example, an Overview selection element 101 may display a user interface having an overview of the selected group and a Past Events selection element 101 may display a user interface providing specific information regarding specific past event information for the group. The past event information may include any or all of the stored past event information for the group.

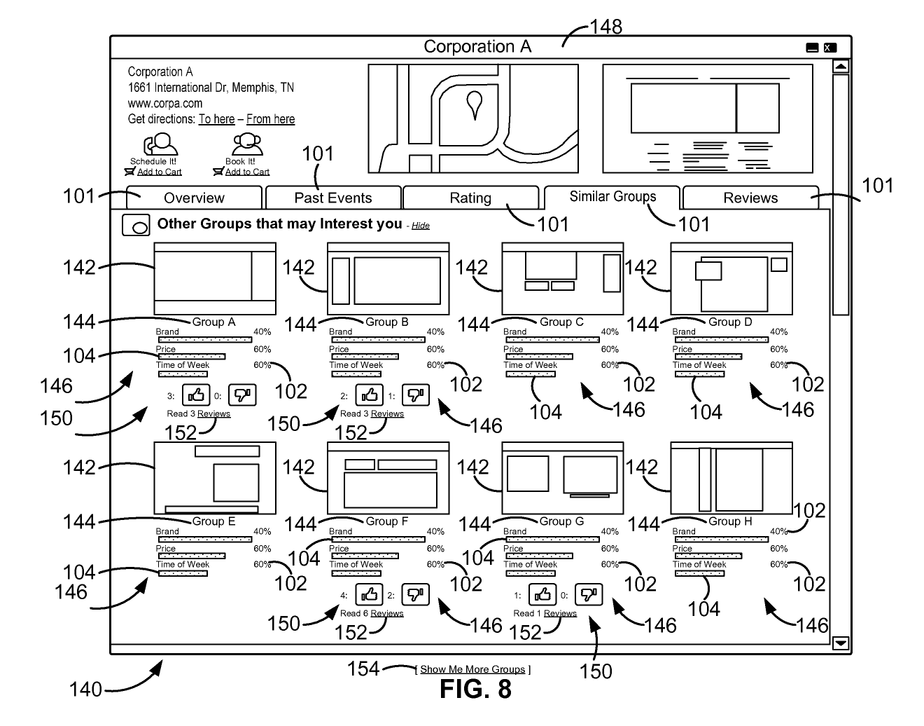

A Similar Groups selection element 101 may display a user interface 140 as shown in FIG. 8 that displays similar groups that may be of interest based on the indicator scoring for a current selected group or based on the determined criteria. As shown, a plurality of identified groups are displayed, which includes a graphic 142 and associated text 144 corresponding to each of the plurality of groups. Additionally, a score portion 146 is displayed in combination with the graphic 142 and associated test 144 for each group, which shows the percentage score value 102 and a corresponding graphic indicator 104 for one or more indicators for that group and that is calculated as described in more detail herein.

The selection of the groups for display on the user interface 140 may be based on different factors. For example, in some embodiments, the groups are selected based on having the same score for one or more indicators as the selected group of interest. For example, as illustrated in the user interface 140, each of the groups has a Brand percentage score of 80%, a Price percentage score of 60% and a Time or Week percentage score of 40%, which are the same percentage indicator scores as that for Corporation A, identified by the text 148. It should be noted that the indicator(s) or criteria used to select similar groups may be predetermined or user defined. Additionally, the similar groups may be selected based on indicator scores that are similar to, but not necessarily the same as the indicator scores for the selected group (Corporation A). For example, the indicator score may be within plus or minus 10% of the indicator score of the selected group. However, it should be noted that the similar groups may be determined based on different criteria or factors. For example, the similar groups may be determined as described herein.

It should be noted that additional information may be provided in connection with each of the groups, for example, reviews (e.g., individual reviews) that may be accessed by selecting a review graphic 150, a Reviews selection element 152 or a Reviews selection element 101. Additionally, a selection element 154 may be provided to access additional similar groups that may have the similar qualities as the displayed groups or different qualities, for example, groups having indicator scores that are the similar, but not the same as the current group.

Thus, various embodiments of the invention provide a method and system for generating sales lead information and for initiating the generation of the sales lead information from a single user interface screen. The sales lead information may be based on different criteria or indicators, such as using past event information.

It should be noted that the various embodiments or components, for example, the computer implemented or computer aided components or the systems described herein may be implemented as part of one or more computer systems, which may be separate from or integrated with other systems, for example, via a network. The computer system may generally include a computer, an input device, a display unit and an interface, for example, for accessing the Internet. The computer may include a microprocessor. The microprocessor may be connected to a communication bus. The computer may also include a memory. The memory may include Random Access Memory (RAM) and Read Only Memory (ROM). The computer system further may include a storage device, which may be a hard disk drive or a removable storage drive such as a floppy disk drive, optical disk drive, and the like. The storage device may also be other similar means for loading computer programs or other instructions into the computer system.

As used herein, the term “computer” may include any processor-based or microprocessor-based system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer system executes a set of instructions that are stored in one or more storage elements, in order to process input data. The storage elements may also store data or other information as desired or needed. The storage element may be in the form of an information source or a physical memory element within the processing machine.

The set of instructions may include various commands that instruct the computer as a processing machine to perform specific operations such as the methods and processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. For example, the ordering of steps recited in a method need not be performed in a particular order unless explicitly stated or implicitly required (e.g., one step requires the results or a product of a previous step to be available). While the dimensions and types of materials described herein are intended to define the parameters of the invention, they are by no means limiting and are exemplary embodiments. Many other embodiments will be apparent to those of skill in the art upon reviewing and understanding the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method, implemented at least in part by a computing system, the method comprising:
receiving a request for sales lead information corresponding to a time slot in a displayed user interface calendar and based on selection of a selection element in the time slot of the user interface calendar;
associating the time slot with time slot criteria for searching for groups, wherein information relating to the groups is stored in database;
determining at least one group satisfying the time slot criteria; and
generating sales lead information relating to the at least one group.

2. A method in accordance with claim 1 further comprising receiving a single input from a user interface selection device to initiate the request for sales lead information.

3. A method in accordance with claim 1 wherein the time slot criteria comprises at least one of a time criterion and a date criterion corresponding to an available space in a venue for the time slot.

4. A method in accordance with claim 1 further comprising displaying the sales lead information.

5. A method in accordance with claim 1 wherein the sales lead information comprises past activity information.

6. A method in accordance with claim 1 wherein the sales lead information comprises scoring information.

7. A method in accordance with claim 1 wherein the time slot corresponds to an available space in a venue.

8. A method in accordance with claim 7 further comprising identifying other non-time slot criteria based on information stored in the database relating to the space in the venue.

9. A method in accordance with claim 8 further comprising determining at least one group satisfying the non-time slot criteria and generating sales lead information relating to the group.

10. A method in accordance with claim 1 further comprising identifying other non-time slot criteria based on user defined preferences.

11. A method in accordance with claim 1 wherein the time slot criteria comprises a predetermined threshold criteria.

12. A method in accordance with claim 1 further comprising displaying the sales lead information and providing a selection element selectable to initiate a request to set up a meeting with the at least one group.

13. A method in accordance with claim 1 further comprising generating similar group information relating to other groups and based on the group.

14. A method in accordance with claim 13 wherein generating similar group information is based on a score value for each time slot criteria for the group.

15. A user interface for requesting sales lead information, the user interface comprising:
a calendar matrix including a plurality of cells corresponding to time slots for a space in a venue; and
a selection element in at least one available time slot, the selection element selectable by a user interface selection device to initiate generation of sales lead information.

16. A user interface in accordance with claim 15 wherein at least one of the plurality of cells comprises a plurality of sub-cells.

17. A user interface in accordance with claim 15 wherein the selection element is provided only in cells corresponding to open time slots.

18. A user interface in accordance with claim 15 wherein the selection element comprises Suggest Group text.

19. A computer program product for scoring groups, the computer program product embodied on one or more computer-readable storage media and comprising computer-readable program code causing a computing device to perform the method of:
receiving a request for sales lead information corresponding to a time slot in a displayed user interface calendar and based on selection of a selection element in the time slot of the user interface calendar;
associating the time slot with time slot criteria for searching for groups, wherein information relating to the groups is stored in database;
determining at least one group satisfying the time slot criteria; and
generating sales lead information relating to the at least one group.

20. A system for generating sales lead information comprising:
a user interface configured to receive a request for sales lead information corresponding to a time slot in a displayed user interface calendar and based on selection of a selection element in the time slot of the user interface calendar by a user interface selection device;
a computer configured to associate the time slot with time slot criteria for searching for groups, wherein information relating to the groups is accessed from a database, the computer further configured to determine at least one group satisfying the time slot criteria and generate sales lead information relating to the group; and
a display configured to display the sales lead information.

21. A system in accordance with claim 20 wherein the display is configured to display a calendar matrix with a plurality of cells corresponding to the time slots and wherein the selection element is displayed in at least one cell corresponding to an available time slot.
